(19) United States
(12) Patent Application Publication
(10) Pub. No.: US 2005/0162711 A1
(43) Pub. Date: Jul. 28, 2005

(54) Digital picture frame with picture acquisition

(75) Inventor: Ming-Che Wu, Tai-Nan City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: MUSTEK SYSTEMS INC.

(21) Appl. No.: 10/765,060

(22) Filed: Jan. 28, 2004

(51) Int. Cl. H04N 1/04

(52) U.S. Cl. 358/474

(57) ABSTRACT

An digital picture frame capable of acquiring image of the picture independently, especially to digitalize the image of photos to a digital format and then display it on a display panel. The digital picture frame includes a display module which supports the image display, a scanning module which scans photos, and an input/output module for image delivery over external image processing/storing devices, such as the hard disk, camcorder, digital still camera and network image server.

### BACKGROUND OF THE INVENTION

1. Field of the Invention

The present invention generally relates to a method of a digital electronic photo frame, especially relating to a digital photo frame which is able to display images on a monitor by means of digital signals recorded from a traditional photo. The significant part of this device is a built-in scanning device, which could scan the photo directly from a traditional photo and display it on the monitor of this frame.

2. Background Description

Since human started to draw on cave walls, the ways of storage and recording of images developed with human history. We now developed many painting techniques and media such as oil painting, Chinese black-white painting, photographing and others. Besides, images are memory more than just a recording for us. Therefore, many families and individuals prefer to keep significant or beautiful, happy things in photo frames and watch them occasionally. But traditional frames can not change photos according to the preferences of users, and need users to change them manually.

Besides that, the pictures which users choose from there photo albums usually cannot match with the size of frames. So that they need to reprint the photos from negative prints in photo labs. That's why users do not change their framed photos so often. Indirectly, the beautiful memory and images in frames are faded out in the end. It's a mentally lost which is caused by the inconvenience of physical operation.

Because of the down-sloping of prices of electronic parts, many integrated and convenient living accessories joined our everyday life. Due to inconvenience of traditional photo frames, electronic photo frames were developed and manufactured as a new option for us. What we called electronic frame is a device transferring images into the memory of the electronic frames and display the image in memory by integrated monitor (usually LCD, now OLED, LTPS LCD are also available). According to the size of memory, we can save more than one picture in the frame and display the images by the modes set by user's preferences.

There are several ways to transfer the data in electronic frames: computer connection (by RS232, USB . . . etc.), memory card connection (by CF card, SD card . . . etc.) and network connection. The former two methods are widely utilized for data transferring. They are somehow convenient but some accessories like computer or digital cameras are needed and the cost is high. Users also need to know basic operations of computers.

Besides, in the moment of data transferring, sometimes the photo frame must move its location to the location of computer and inconvenience will occur. As home electronics, there are some significant points: easy to learn and use, low cost of must-have accessories, and high integrated. As a home appliance, the digital picture frame could hardly achieve any one of them.

For the third way of connection, although it could achieve the functions of long distance image sharing and electronic secretary, but the prerequisite of this method is the presence of broad-band internet connection, or the environment of LAN connection. Even if we use the convenient wireless internet connection, we still need some cost of peripheral accessories, such as a access point device or a wireless router. Besides, since Internet service is applied, there is an additional cost of Internet connection fee, or service fee of photo sharing over internet photo servers.

Based on the restrictions mentioned above, it also makes the traditional electronic frame less mobile. It could not change pictures easily in the environment which is far from computer and internet, especially for the method of internet connection. Besides, the using and operation habits of existed electronic frame are closer to computer. It generates a barrier for most people, and the practicability of electronic frame is effected.

### SUMMARY OF THE INVENTION

According to the deficiency of prior arts, this goal of this invention is to use built-in photo scanner or digital cameras to capture images, generate digital signals and save the image in memory for later use of displaying on the display panel.

The other intent of this invention is to match using habits of traditional electronic frames. A user puts a physical photo into the electronic photo frame and digital images will be shown on the display screen in the frame. It's also available to perform the operation of inserting physical photos for multiple times and multiple digital photos will be saved in memory. The refreshing of photos could be performed automatically. And the inconvenience of going to photo labs could be avoided.

Another intention of this invention is to utilize the digital picture frame as a mobile presentation tool. In additional to watch the image of charts directly, the image could also be transferred to outer TV or projector. It's even easier to change the order of images by the remote controller.

According to what described above, this invention provides an image capturing electronic photo frame. It includes a processor which connects a memory module for image processing. The display device connects the processor for image displaying. In the image capturing electronic photo frame mentioned above, it also includes one storage device which is used to store images.

For the image capturing electronic photo frame mentioned above, one better embodiment is consisted of a display device for image displaying, a scanning device for scanning photo, and an input/output device connecting the display device.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows the system diagram of this invention;

FIG. 2 shows the diagram of this device employed in a presentation;

FIG. 3 shows the present invention at the scanning status; and

FIG. 4 is shows the invention connecting to a TV for displaying the scanned image of a print.

### DETAILED DESCRIPTION OF A PREFERRED EMBODIMENT OF THE INVENTION

In order to provide a clear description and better understanding, charts/diagrams are not drawn in portion and relative scale. The size of some parts is also exaggerated compared in scale to other related parts. To be more concise, irrelative details are not drawn completely.

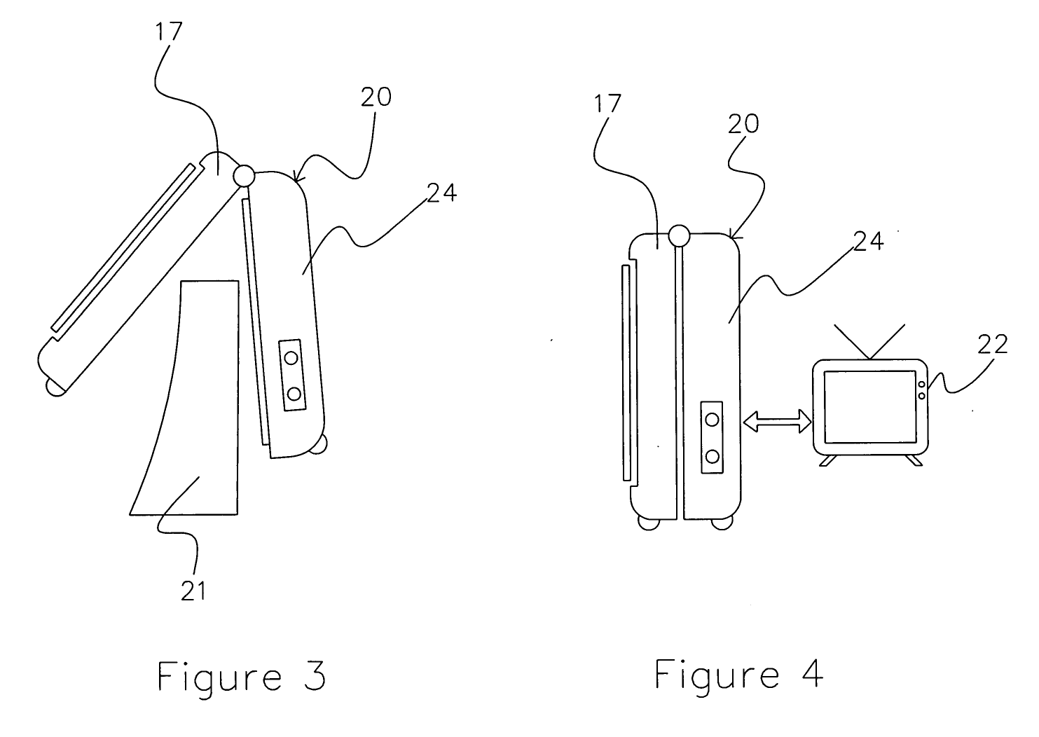

Firstly, please refer to FIGS. 3 and 4. This invention of digital picture frame 20 includes a display panel 17 and a scanning module 24. The display panel 17 is acted as a front cover of the scanning module 24. The rear body of the digital picture frame 20 is the scanning module 24. The display panel 17 has a display screen (not shown in the drawing) which is a Liquid Crystal Display (LCD, relatively stable in quality and reasonable in cost) However, the Organic Light-Emitting Device (OLED) and Low Temperature Poly Silicon (LTPS) could also be used. The scanning module 24 of rear body assembly in FIG. 4 is a platform scanning device and can be replaced by other type of scanning device. The digital image can be shown not only on the display panel 17 but on the external monitor, TV or projector through terminals.

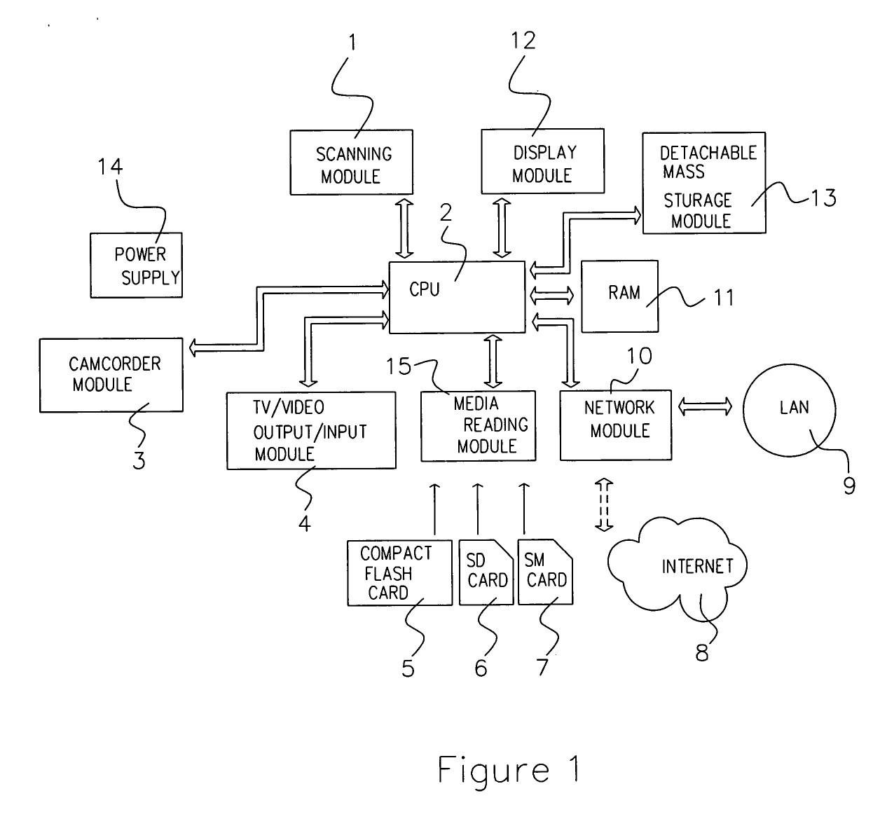

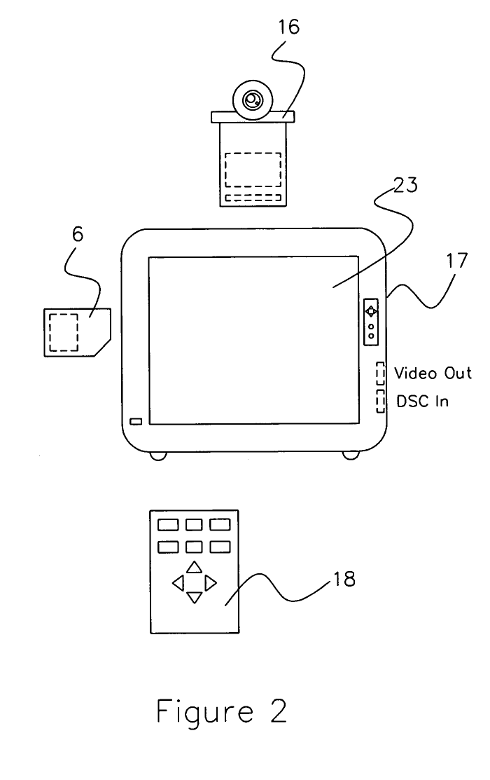

Like what has been shown in FIG. 3, display panel 17 can be lift apart from the scanning module 24. When the scanning module 24 is placed horizontally, a print 21 or photo picture can be scanned directly by putting the print 21 on the scanning platform 24. If the scanning device 24 is positioned vertically, the display panel 17 acts as a front cover to hold the print 21. Therefore, the scanning could be performed after the cover closing to prevent slipping of the print or the photo picture. Besides what mentioned above, the digital picture frame can take digital image by a camera as well when the camera is attached and connected. As in FIG. 2, the camera 16 could be connected with the digital picture frame 20 by a cable or a connection junction. And it can take still or moving pictures, and further save the images in the memory which was built-in in the digital picture frame. The saved images can later be shown on the display panel 17. Please notice that the camera 16 in FIG. 2 connects the digital picture frame via signal connection. In addition to that, the digital picture is able to acquire digital images by external video devices, such as DV, TV, DVD player and DSC, via the TV/Video output/input module 4 and the camcorder module 3 (See FIG. 1). Furthermore, the digital picture frame 20 includes a media reading module 15 to read memory card as well, such as compact flash card 5, SD card 6 or SM card. It makes the data transfer from different specification of memory cards to the memory 11 (RAM) of the digital picture frame easier. In an presentation situation, a remote 18 is provided to control the digital picture frame 20 to perform image displaying.

The system diagram of the present invention of the digital picture frame 20 is again shown in FIG. 1. A power supply 14 keeps the electronic photo frame working. This power supply 14 could be a voltage converter or built-in batteries. Scanning module 1 transfer the scanned digital images to processor 2, and later transfer the images into the memory 11 after the procedure of image processing. It is also available to install a detachable mass storage module 13, like a hard disk or a CD/RW, in order to store more image data. When playing the images, the saved images were read firstly from the mass storage module 13 or from the memory 11 and then transfer to processor 2. After that, the digital images will be shown by transferring the image data to the display panel by display module 12. Besides accusing digital images from scanning module, the present invention of digital picture frame can perform still or moving picture recording by the photographing module or the camcorder module 3 as shown, or an external camera 16. It can also read digital images through the media reading module 15 (such as a card reader) to read memory cards of different specifications (like CF card 5, SD card 6 or SM card 7). In a network environment, the present invention of digital picture frame is able to acquire digital images (with an internet connection fee when the images are stored on an internet photo servers), via a network module 10 by connecting to photo servers through LAN 9 or internet 8. In a presentation environment, the digital picture frame outputs images to an external TV, projector or recorder through TV/Video Output/Input module 4, and the order and speed of image displaying could be controlled by a remote controller.

Therefore, the picture acquisition process of the present invention will be performed like operating a home electronic or a home appliance. The scanned images will be shown on the body. In the prerequisite of fixed resolution and colors, the efficiency of scanning can be optimized, and users can almost sense no operation of scanning. Besides, in a simplified operating environment, users don't need to do any setting. It just matches with the basic spirit of home electronics, which is easy to use. In addition, the built-in memory and rechargeable batteries let this device more mobile. It can be used as a presentation device as well. More than just watch the images or charts directly, it could also connect external TV or projector. Used with a remote controller, image playing can be controlled easily.

Although preferred embodiments of the present invention have been described in the forgoing description and illustrated in the accompanying drawings, it will be understood that the invention is not limited to the embodiments disclosed, but is capable of numerous rearrangements, modifications, and substituting of parts and elements without departing from the spirit and scope of the invention. Accordingly, the present invention is intended to encompass such rearrangements, modifications, and substitutions of parts and elements as fall within the scope of the appended claims.

1. A digital picture frame capable of picture acquisition, comprising:
a display module for displaying a picture;
a scanning module for scanning a print to acquire said image of said print;
an input/output module, connecting said display module and said scanning module for outputting said image to a external display device, and for inputting an auxiliary image from an external image module.

2. The digital picture frame capable of picture acquisition of claim 1 further comprising a memory module to store said image and said auxiliary image for transmitting to said displaying module.

3. The digital picture frame capable of picture acquisition of claim 1 further comprising a processor, connecting said display module, said scanning module and said input/output module for coordinating image data processing.

4. The digital picture frame capable of picture acquisition of claim 1 further comprising a power supply module for supplying power to said digital picture frame for operation.

5. The digital picture frame capable of picture acquisition of claim 1, wherein said external image module is an image capturing device.

6. The digital picture frame capable of picture acquisition of claim 5, wherein said image capturing device is a digital still camera.

7. The digital picture frame capable of picture acquisition of claim 5, wherein said image capturing device is a camcorder via a camcorder module to connect to said digital picture frame.

8. The digital picture frame capable of picture acquisition of claim 1, wherein said external image module is a card reader for reading a memory card.

9. The digital picture frame capable of picture acquisition of claim 1, wherein said external image module is a hard disk.

10. The digital picture frame capable of picture acquisition of claim 1, wherein said external image module is a image server, accessible over a network connection.

11. The digital picture frame capable of picture acquisition of claim 1, wherein said external display device is a projector.

12. The digital picture frame capable of picture acquisition of claim 1, wherein said display module is a liquid crystal panel display.

13. A digital picture frame capable of picture acquisition, comprising:
a processor connecting to a memory module for performing image processing;
a display module connecting to said processor for displaying an image stored in said memory module;
a scanning module scanning a print to acquire said image;
a photographing module connecting to said processor for delivering moving pictures;
a media reading module connecting to said processor for transmitting photo images stored in a memory card;
a network module connecting to said processor for retrieving network images through a network image server; and
a visual input/output module for inputting visual images from an external image device and for outputting said image to said external image device.

14. The digital picture frame capable of picture acquisition of claim 13 further comprising a mass storage device for providing a mass storing capacity.

15. The digital picture frame capable of picture acquisition of claim 14, wherein said mass storage device is a hard disk.

16. The digital picture frame capable of picture acquisition of claim 13, wherein said external image device is a television.

17. The digital picture frame capable of picture acquisition of claim 13, wherein said memory card is a compact flash card.

18. The digital picture frame capable of picture acquisition of claim 13, further comprising a camcorder which is connected with said camcorder module.

19. The digital picture frame capable of picture acquisition of claim 13, wherein said media reading module is a card reader.

20. The digital picture frame capable of picture acquisition of claim 13, wherein said external image device a still digital camera.
